(19) United States
(12) Patent Application Publication
(10) Pub. No.: US 2002/0024914 A1
(43) Pub. Date: Feb. 28, 2002

(54) Recording apparatus and method, reproducing apparatus and method, and recording medium

(76) Inventor: Shoei Kobayashi, Kanagawa (JP)

Correspondence Address: FROMMER LAWRENCE & HAUG LLP, 745 FIFTH AVENUE, NEW YORK, NY, 10151, US

(21) Appl. No.: 09/942,852

(22) Filed: Aug. 29, 2001

(30) Foreign Application Priority Data
Aug. 31, 2000 (JP) P2000-262061

(51) Int. Cl. G11B 7/24

(52) U.S. Cl. 369/109.01; 369/275.4

(57) ABSTRACT

Address information composed of embossed pits and recorded in a ROM track is formed while being wobbled in accordance with a wobble signal. When a recording medium such as a disk containing wobbled address information is to be reproduced, both the address information read out and sync information obtained from the wobble signal are used for reproduction of recorded data. Since a sync signal is thus obtained from the wobbling, an exact operation of reproducing the recorded data can be performed with certainty even in case the address information is read out merely partially due to some harmful influence caused by the existence of dust or the like deposited on the surface of the disk.

### BACKGROUND OF THE INVENTION

The present invention relates to a recording apparatus and method, a reproducing apparatus and method, and a recording medium. More particularly, it relates to those adapted to execute various processes by the use of data composed of embossed pits and formed while being wobbled, and also by the use of sync information obtained from such wobbling.

As a method of forming addresses on an optical disk, there is known a method of forming embossed pits in manufacture of an optical disk. For example, an optical disk is blocked into sectors each having 2048 bytes as a unit of user data in recording and reproduction, wherein a sector address is formed as a header at the beginning of each sector.

In a recording/reproducing apparatus for recording data on such an optical disk and/or reproducing the recorded data therefrom, first a desired address is detected by reading the sector address and, after confirmation thereof, data are recorded on and/or reproduced from a recording/reproducing area which follows the relevant header.

For example, a CD (compact disk), which is one kind of optical disks, has a thickness of approximately 1.2 mm (thickness of its light transmission layer to conduct a laser beam to an information recording plane), so that harmful influence derived from dust or the like on the surface of the disk is relatively small. However, in case the thickness of an optical disk is set to be 0.1 mm or so, there arises a problem that the harmful influence caused by any dust or the like on the disk surface is rendered great and non-negligible.

It becomes possible, by thinning a disk, to raise the numerical aperture (NA) of a lens and to reduce the wavelength of a laser beam. In other words, it is necessary to thin a disk in a recording and/or reproducing operation performed with a raised NA of a lens and a reduced wavelength of a laser beam. Although the recording density can be increased by reducing the laser beam wavelength, there arises another problem that different harmful influence due to skew or the like is rendered greater.

Such harmful influence derived from dust, skew or the like can be diminished by enhancing the error correction capability with regard to the data recorded in the recording/reproducing area. However, regarding the address, the capacity of the header for writing the address is small, and the set capacity is not sufficient to enhance the error correction capability. And even if the set capacity is sufficient, it becomes redundant to consequently lower the format efficiency.

### SUMMARY OF THE INVENTION

The present invention has been accomplished in view of the circumstances mentioned above. And it is an object of the present invention to provide improvements wherein address data and so forth composed of embossed pits are also formed while being wobbled, so that a desired position on a disk can be specified by using both the address information composed of the embossed pits and sync information obtained from such wobbling.

According to a first aspect of the present invention, there is provided a recording apparatus comprising first forming means to form grooves, second forming means to form pits, and generating means to generate a predetermined frequency, wherein the first and second forming means form the grooves and the pits, respectively, by wobbling the same in accordance with the frequency generated by the generating means.

According to a second aspect of the present invention, there is provided a recording method which comprises a first forming step to form grooves, a second forming step to form pits, and a generating step to generate a predetermined frequency. The first forming step and the second forming step are executed to form the grooves and the pits, respectively, by wobbling the same in accordance with the frequency generated at the generating step.

According to a third aspect of the present invention, there is provided a recording medium where a program is recorded in a manner to be readable by a computer. The program comprises a first forming step to form grooves, a second forming step to form pits, and a generating step to generate a predetermined frequency. The first forming step and the second forming step form the grooves and the pits, respectively, by wobbling the same in accordance with the frequency generated at the generating step.

According to a fourth aspect of the present invention, there is provided a reproducing apparatus for reproducing data composed of pits and recorded on a recording medium, wherein the pits are formed while being wobbled, and the data are reproduced by the use of a sync signal obtained from the wobbling.

According to a fifth aspect of the present invention, there is provided a reproducing method for reproducing data composed of pits and recorded on a recording medium, wherein the pits are formed while being wobbled. The method comprises a step of reproducing the data by the use of a sync signal obtained from the wobbling.

According to a sixth aspect of the present invention, there is provided a recording medium where a program is recorded in a manner to be readable by a computer. The program is executed to reproduce data which are composed of pits and are recorded on the recording medium, wherein the pits are formed while being wobbled, and the data are reproduced by the use of a sync signal obtained from the wobbling.

And according to a seventh aspect of the present invention, there is provided a recording medium containing recorded grooves and pits, wherein the grooves are formed while being wobbled, and the pits are also wobbled in the same period as that of the grooves.

The pits include address information, and the address information is composed of at least one of PLL pull-in information, segment mark, address mark, address, and error detection code.

The wobbling amplitude to the pits is more than twice the wobbling amplitude to the grooves. And the pits are formed in CAV (constant angular velocity) zones.

The grooves and the land interposed between the grooves are formed in CAV zones respectively, and each of the grooves and the lands is composed of an address part and a data part. The address parts of the grooves and the address parts of the adjacent lands are formed in zigzag.

In the recording apparatus of the first aspect, the recording method of the second aspect and the recording medium of the third aspect, the grooves and the pits are formed while being wobbled in accordance with the generated frequency.

In the reproducing apparatus of the fourth aspect, the reproducing method of the fifth aspect and the recording medium of the sixth aspect, the data are composed of pits, and the data are reproduced from the recording medium, where the wobbled pits are recorded, by the use of a sync signal obtained from the wobbling.

And in the recording medium of the seventh aspect, there are recorded the wobbled grooves and the pits wobbled in the same period as that of the grooves.

The above and other features and advantages of the present invention will become apparent from the following description which will be given with reference to the illustrative accompanying drawings.

### BRIEF DESCRIPTION OF THE DRAWINGS

FIG. 1 is a block diagram showing the configuration of a mastering apparatus where the present invention is applied;

FIG. 2 is a schematic diagram for explaining the structure of an optical disk 11;

FIG. 3 illustrates how wobbling is performed;

FIG. 4 shows the data composition in a header;

FIG. 5 is a diagram for explaining the data recorded in ROM tracks;

FIG. 6 is a block diagram showing the configuration of a recording/reproducing apparatus 21;

FIG. 7 is a flowchart for explaining the operation performed in the recording/reproducing apparatus 21;

FIG. 8 is a diagram for explaining an ECC block cluster;

FIG. 9 is a diagram for explaining an error correction block;

FIG. 10 is a block diagram showing the internal configuration of a wobble circuit 23;

FIG. 11 illustrates how wobbling is performed; and

FIG. 12 is a diagram for explaining a recording medium.

### DETAILED DESCRIPTION OF THE PREFERRED EMBODIMENTS

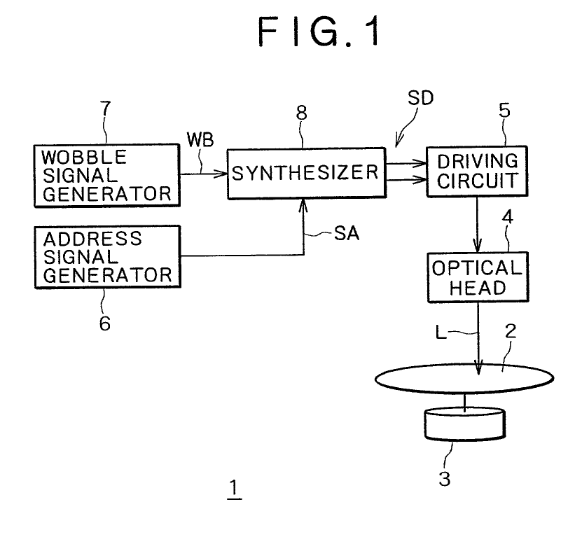

Hereinafter some preferred embodiments of the present invention will be described in detail with reference to the accompanying drawings. FIG. 1 is a block diagram showing the configuration of a mastering apparatus 1 where the present invention is applied for manufacture of an optical disk master. A disk master 2 is exposed by the mastering apparatus 1, and optical disks are manufactured from the disk master 2. In the mastering apparatus 1, the disk master 2 consists of, e.g., a glass substrate whose surface is coated with resist, and is driven by a spindle motor 3 to rotate under condition of a constant angular velocity.

An optical head 4 irradiates a laser beam L onto the disk master 2 while being displaced by a predetermined sled mechanism in synchronism with the rotation of the disk master 2 successively from the innermost portion of the disk master 2 toward the outermost portion thereof. Tracks are formed by such irradiation of the laser beam L onto the disk master 2.

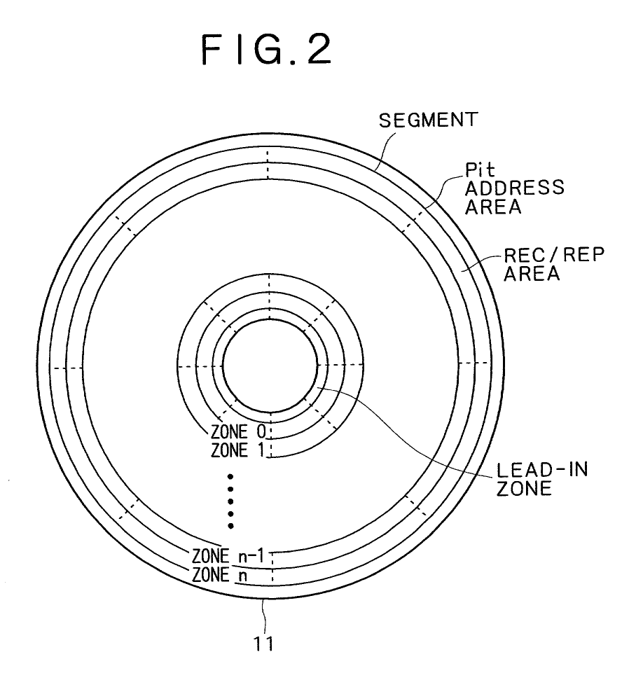

FIG. 2 is a schematic diagram for explaining the format of an optical disk manufactured on the basis of the disk master 2. On an optical disk 11, a total of n+1 zones ranging from 0 to n are formed from the innermost portion to the outermost portion, wherein each zone is composed of eight segments. A pit address area is formed at the beginning of each segment, and a recording/reproducing area is formed in succession to the pit address area. And a lead-in zone is formed inside the innermost zone 0.

The pit address areas in the zones are formed radially to maintain a constant angular velocity (CAV) in such a manner that the innermost density in each zone becomes equal.

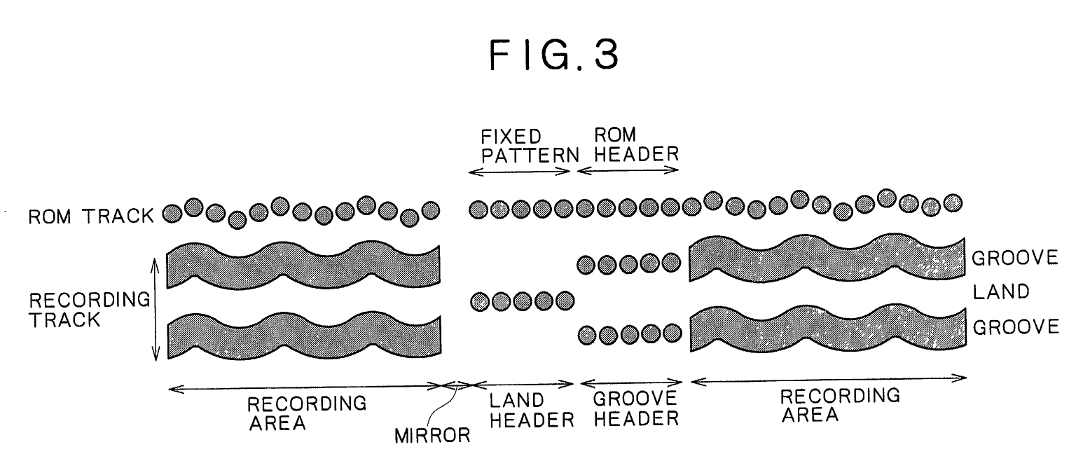

FIG. 3 is a diagram for further explaining the format of the optical disk 11. On the optical disk 11, there are formed a ROM (read only memory) track and a recording track. The ROM track is formed in the lead-in zone, while the recording track is formed in the zones 0 to n. And in the recording track, there are formed grooves and lands. Each groove is composed of a groove header and a recording area formed in succession. Similarly, each land is composed of a land header and a recoding area formed in succession.

As shown in FIG. 3, a groove address (data composed of embossed pits) described in the groove header and a land address described in the land header are formed in time series without being adjacent to each other (so that the groove address and the land address may not overlap with each other when the addresses are displaced vertically in FIG. 3).

Thus, the groove addresses and the land addresses are formed successively in the track direction and radially, whereby it becomes possible to prevent that the embossed pits are difficult to be formed due to narrowed track pits or that the crosstalk between the land address and the groove address is increased mutually to render the addresses unreadable.

A mirror part is formed anterior to each groove header and land header. The mirror part is used for canceling the offset of a servo signal and so forth.

Each groove in the recording area is formed while being wobbled at a fixed frequency. In a reproduction mode, sync information can be acquired according to a wobble signal obtained from the wobbled groove.

In the innermost zone 0, wobbles are formed with 420 waves in one segment, and 6 waves are increased per segment in accordance with an increment 1 of the zone number. Therefore, in the outermost zone n, wobbles are formed with 420+6 waves in one segment. Describing in unit of zone, wobbles are formed with 3360 waves (=420×8) in the zone 0, and 48 waves are increased in accordance with an increment 1 of the zone number. Consequently, in the outermost zone n, wobbles are formed with 3360+48n waves.

In the ROM track, there are formed a fixed pattern and a ROM header. The fixed pattern is formed at a position corresponding to the land header in the recording track. The pattern may be a fixed one or, in some cases, a random one. The fixed pattern is composed of embossed pits. The ROM header is formed at a position corresponding to the groove header in the recording track.

The ROM track pitch is equalized to the land pitch on the basis of the lands in the recording track and also to the groove pitch on the basis of the grooves therein. The data composed of embossed pits in the recording area next to the ROM header are formed while being wobbled in the same wavelength as that of the grooves in the recording track. And the wobble amplitude of the data is set to be twice the wobble amplitude of the grooves. It is a matter of course that the former amplitude may be more than twice as well.

As the wobble amplitude in the ROM track is modulated by pits, it becomes half the amplitude of the grooves as a natural result. For this reason, as mentioned above, the wobble amplitude in the ROM track is set to be twice (or more) the wobble amplitude of the grooves, whereby the wobble amplitude in the ROM track is rendered equal to or more than the wobble amplitude of the grooves, hence ensuring exact acquisition of wobble signal in the ROM track also.

Referring back to the mastering apparatus 1 of FIG. 1, a wobble signal generator 7 generates, as a wobble signal WB, a sine wave signal of a predetermined frequency synchronized with the rotation of the disk master 2, for wobbling predetermined data in the ROM track and the recording track.

An address signal generator 6 generates and outputs an address signal SA whose value is changed under control of a system controller (not shown) in accordance with a displacement of the optical head 4. That is, the address signal generator 6 acquires, from the spindle motor 3 or the like, a timing signal synchronized with the rotation of the disk master 2 and counts the timing signal by means of a predetermined counter.

A synthesizer 8 synthesizes the wobble signal WB, which is obtained from the wobble signal generator 7, with the address signal SA from the address signal generator 6, thereby producing a drive signal SD composed of a displacement signal to displace the optical system of the optical head 4 and a light quantity control signal to control the light quantity of the laser beam. This drive signal SD is outputted to the driver 5.

Now a further explanation will be given on the format of the optical disk 11 produced from the disk master 2 manufactured by the mastering apparatus 1. On the optical disk 11, as shown in FIG. 3, the data composed of embossed pits in the ROM track are also wobbled.

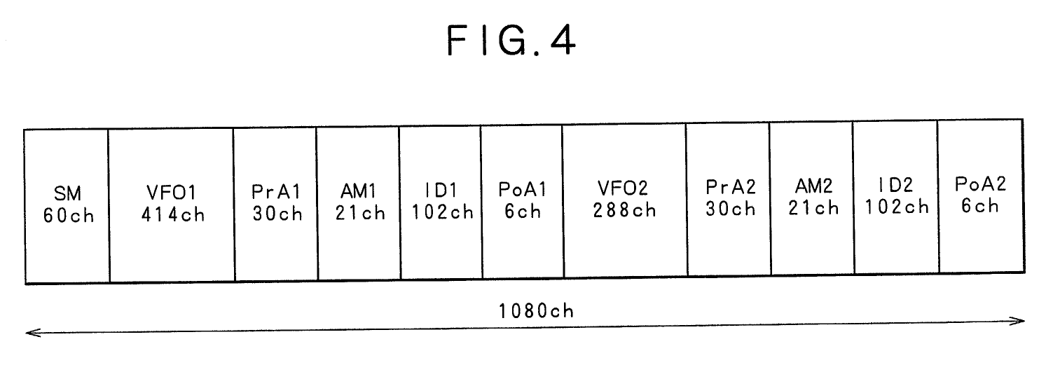

FIG. 4 is a diagram showing the data composition with a layout of a ROM header, a land header and a groove header. Each header is so composed as shown in FIG. 4, wherein SM is a segment mark indicating the beginning of a segment, VFO1 denotes a pattern to pull-in a PLL (Phase Locked Loop) for synchronism, and PrA1 denotes a pattern for executing offset control in AGC (Automatic Gain Control).

AM1 denotes an address mark indicating a sync signal for an address; ID1 denotes a track address, segment address or CRC address; and PoA1 denotes a pattern for satisfying the rule of channel coding.

VFO2 to PoA2 are the same in pattern as the foregoing VFO1 to PoA1 respectively. The reliability can be enhanced by thus recording the same pattern twice. In FIG. 4, numerals denote the relevant channel length.

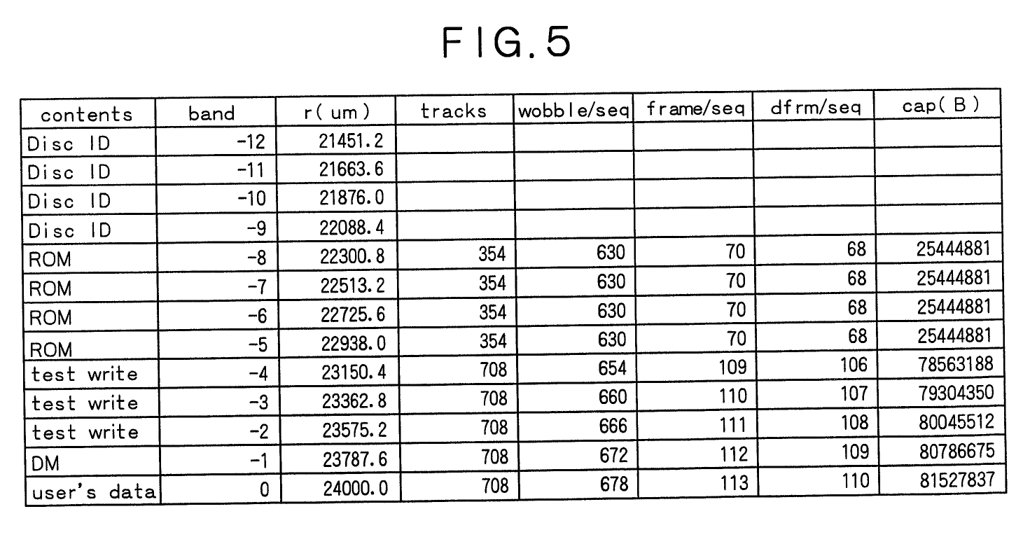

FIG. 5 is an explanatory diagram of patterns recorded in the ROM track. The ROM track is composed of contents (contents), band number (band), disk radius (r(um)), number of tracks (tracks), number of wobbles per segment (wobble/seg), number of frames per segment (frame/seg), number of data frames per segment (dfrm/seg) and capacity (cap(B)).

A unique disk ID signal different from any other disk is recorded in the innermost bands −12 to −9. And a ROM area is formed in bands −8 to −5. In the ROM area, there is recorded disk information which indicates the kind of the disk, version information and so forth. A test write area is formed in bands −4 to −2. This test write area is provided for adjustment of a laser power in a recording mode.

Band −1 is a DM (Defect Management) area for recording control information of defect management relative to replacement sector or the like, and also a defect lift and so forth. Band 0 and subsequent ones are set as a user zone for recording and/or reproducing user data.

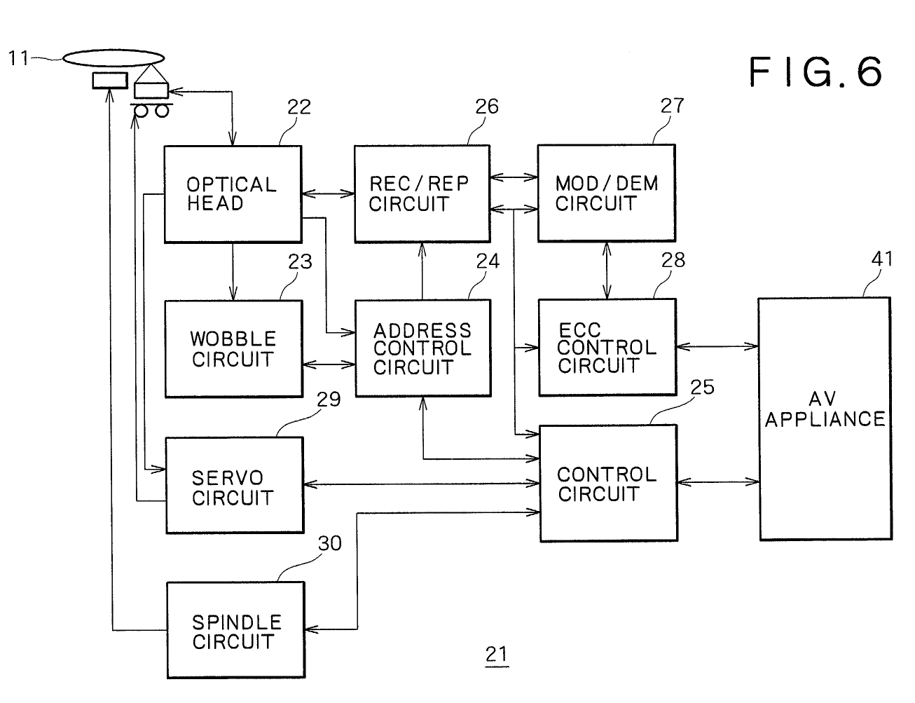

FIG. 6 is a block diagram showing the configuration of a recording/reproducing apparatus which performs recording and reproduction of an optical disk formatted as mentioned above. An optical head 22 is a device comprising an optical system inclusive of an LD (laser diode), a reproducing amplifier and a biaxial actuator. The optical head 22 records signals on the optical disk 11 and/or reproduces the same therefrom. A wobble circuit 23 generates a sync signal out of a wobble signal supplied from the optical head 22 and reproduced from the optical disk 11, and then supplies the sync signal to an address control circuit 24.

The address control circuit 24 decodes the address out of the reproduced signal supplied from the optical head 22, and then supplies the decoded address information to a control circuit 25. Further the address control circuit 24 generates a timing signal out of the sync signal supplied from the wobble circuit 23, and then supplies the timing signal to each of the component circuits in the apparatus. A recording/reproducing circuit 26 executes recording compensation when recording the signal on the optical disk 11. And when reproducing the signal from the optical disk 11, the circuit 26 reproduces binary data by means of a PLL and so forth.

A modulating/demodulating circuit 27 modulates data to be recorded on the optical disk 11, or demodulates the data obtained from the optical disk 11. An ECC (error correcting code) control circuit 28 executes encoding and decoding for error correction. A servo circuit 29 executes servo control for the biaxial actuator and controls the seek of the optical head 22. A spindle circuit 30 control the spindle motor which rotates the optical disk 11. The control circuit 25 controls each component circuit in the recording/reproducing apparatus 21, and also controls communication with an AV (audio visual) appliance 41 consisting of a television receiver or the like.

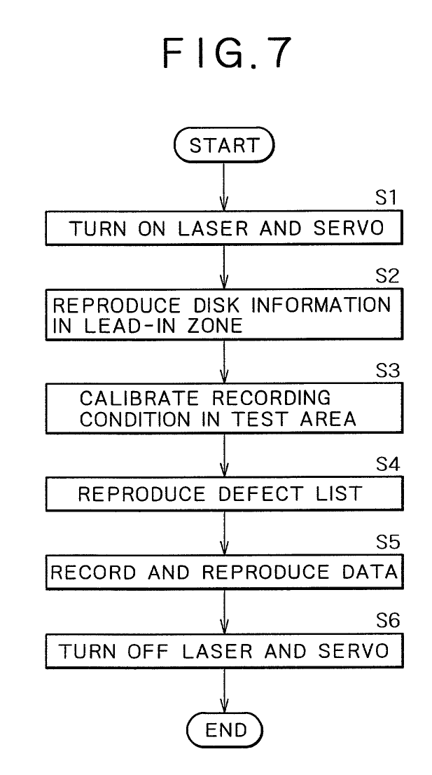

Now the operation of the recording/reproducing apparatus 21 will be described with reference to a flowchart of FIG. 7. First at step S1, upon decision that the optical disk 11 has been loaded in an unshown drive in the recording/reproducing apparatus 21, the laser in the optical head 22 is turned on, and then the spindle motor is driven to start focus, tracking and sled servo control. At step S2, there is read out the disk information (recorded in the bands −12 to −5 explained with reference to FIG. 5) such as the disk format and the version recorded in the lead-in zone inside the innermost zone 0. The disk information is recorded in the shape of embossed pits in the lead-in zone, as described with reference to FIG. 3.

The optimal servo offset is adjusted by the use of the data in the ROM track containing the recorded information of embossed pits, and calibration of the reproducing condition is performed. Then at step S3, the recording operation proceeds to the test area (bands −4 to −2), and recording calibration is performed with regard to the recording power, recording pulse condition, recording servo offset and so forth.

Subsequently at step S4, the defect list recorded in the band −1 is reproduced to execute defect management. At step S5, the operation proceeds to the recording track (FIG. 3), and either recording or reproduction of signals is performed. And at step S6, the servos are turned off in response to a halt command from the user to indicate a stop of the operation, and the laser is also turned off.

Now an explanation will be given below on the reproduction performed at step S5 in the recording/reproducing apparatus 21. When a reproduction command sent from the AV appliance 41 has been received by the control circuit 25, the control circuit 25 acquires the address information from the address control circuit 24 and then enables the servo circuit 29 to execute a seek on the basis of the address information thus acquired, thereby moving the optical head 22 to the position of a desired address on the optical disk 11.

The reproduced signal obtained by the optical head 22 is supplied to the recording/reproducing circuit 26. Then this circuit 26 acquires the reproduced data by the use of a sync signal and so forth obtained out of the input reproduced signal by means of a PLL, and then the reproduced data is outputted to the modulating/demodulating circuit 27. This circuit 27 demodulates the input reproduced data to thereby generate a bit stream, and outputs the same to the ECC control circuit 28.

The ECC control circuit 28 executes error correction for the input bit stream, and then supplies the corrected bit stream to the AV appliance 41.

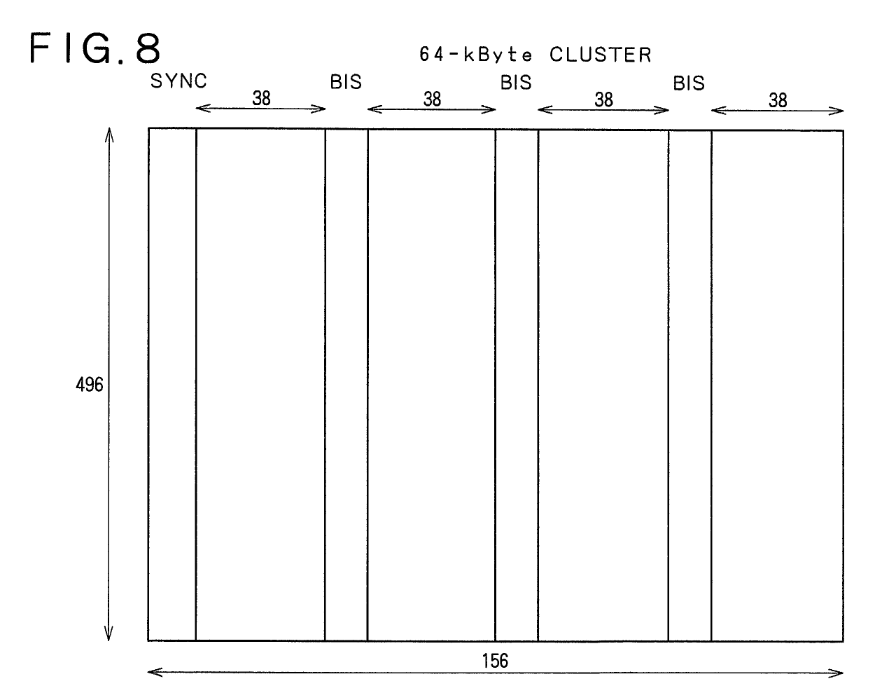

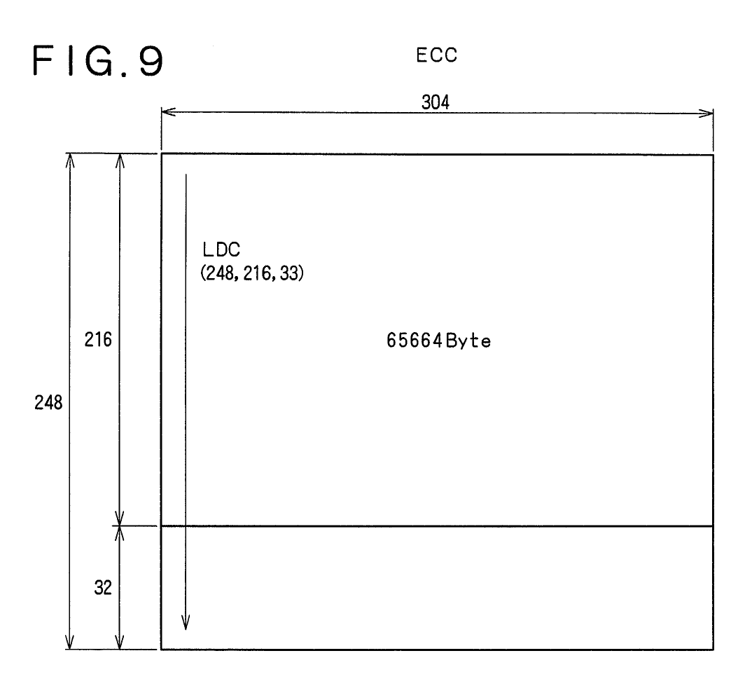

Next, an ECC block cluster will be described below. FIG. 8 shows the composition of an ECC block cluster, wherein recording and reproduction are performed horizontally. In this diagram, SYNC denotes a sync signal, and BIS stands for a burst indicator subcode. When successive symbols with SYNC are errors, SYNC and the data symbol interposed between BIS (SYNC and data between BIS) are regarded as burst error, and a pointer is attached thereto. As shown in FIG. 9, any symbol with an attached pointer is processed through pointer erasure correction by main correction codes LDC (248, 216, 33).

FIG. 9 shows the structure of an error correction block. For error correction, an error correction block is composed of 64-kbyte data. There is a case where recording and reproduction are performed as 2-kbyte data sectors. In such a case, the data are recorded and/or reproduced with an error correction block in unit of 64 kbytes, and desired 2-kbyte data are recorded and/or reproduced out of such 64 kbytes. The error correction code is composed of 216 symbols and 32 parity symbols. And one error correction block is composed of 304 correction codes.

Now an explanation will be given on the recording operation performed in the recording/reproducing apparatus 21 at step S5. In the recording operation of the recording/reproducing apparatus 21, a recording command transmitted from the AV appliance 41 is inputted to the control circuit 25, and an image bit stream encoded in conformity with, e.g., the MPEG-2 (Moving Picture Experts Group) standard is inputted to the ECC control circuit 28. The control circuit 25 recognizes input of the recording command, and then receives an address on the optical disk 11 for recording the image bit stream inputted from the ECC control circuit 28.

The control circuit 25 controls the servo circuit 29 and the spindle circuit 30 in accordance with the address thus received. The servo circuit 29 moves the optical disk 11 to the position of the desired address.

Meanwhile, the image bit stream inputted to the ECC control circuit 28 is encoded for error correction and then is supplied to the modulator/demodulator circuit 27. The modulator/demodulator circuit 27 modulates the input image bit stream in conformity with the recording system of the recording/reproducing apparatus 21, and then supplies the modulated bit stream to the recording/reproducing circuit 26. Subsequently, the recording/reproducing circuit 26 executes recording correction for the input bit stream and then outputs the same to the optical head 22 in accordance with a timing signal supplied from the address control circuit 24. The image bit stream inputted to the optical head 22 is recorded on the optical disk 11, as the output from the semiconductor laser of the optical head 22 is controlled.

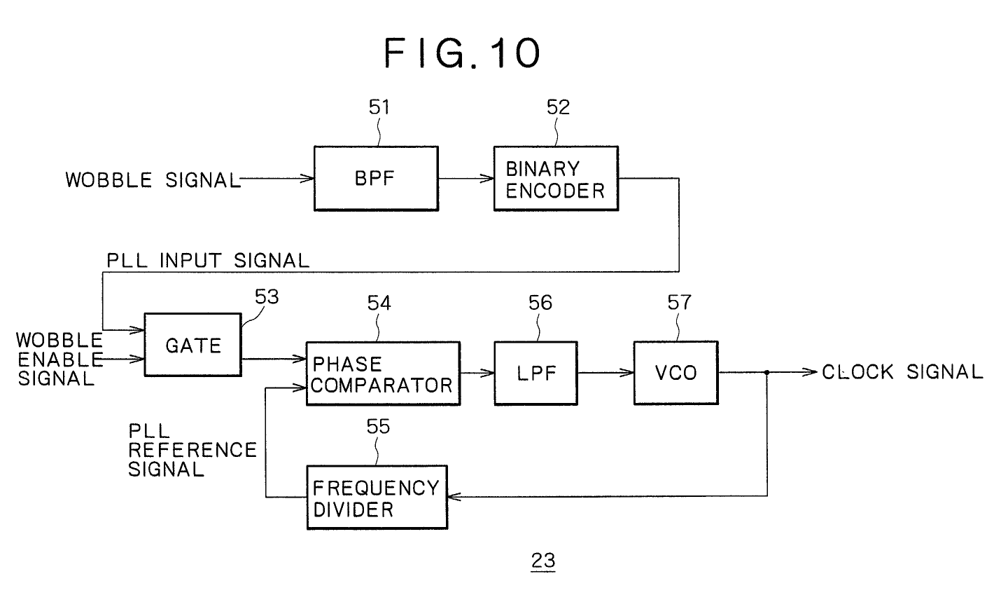

The recording/reproducing apparatus 21 performs such recording or reproduction by using the sync signal which is obtained out of the wobble signal acquired from the optical disk 11. The process relative to the wobble signal is executed by the wobble circuit 23. FIG. 10 is a block diagram showing the internal structure of the wobble circuit 23. The wobble signal supplied from the optical head 22 is inputted to a BPF (band pass filter) 51 in the wobble circuit 23, wherein the wobble signal is obtained from a push-pull (PP) signal. As the wobble signal (push-pull signal) passes through the BPF 51, its wobble frequency component is extracted to thereby acquire the wobble signal.

The wobble signal outputted from the BPF 51 is supplied to a binary encoder 52, where the signal is converted into a binary one. The binary signal thus obtained is supplied as a PLL input signal to a phase comparator 54. Then the phase comparator 54 compares the phase of the PLL input signal received via a gate 53 with the phase of a PLL reference signal from a frequency divider 55, and outputs a phase difference signal, which represents the result of such comparison, to a LPF (low pass filter) 56.

When a wobble enable signal is at a high (H) level, the gate 53 outputs the PLL input signal from the binary encoder 52 to the phase comparator 54. However, if the wobble enable signal is at a low (L) level, the gate 53 holds the PLL input signal supplied from the binary encoder 52, without outputting the signal to the phase comparator 54. Only when the PLL input signal has been received from the gate 53, the phase comparator 54 executes phase comparison with the PLL reference signal, and then outputs a phase difference signal to the LPF 56. The wobble enable signal is supplied from the address control circuit 24.

The LPF 56 extracts only a predetermined low frequency component from the input phase difference signal, and then outputs the extracted component to a VCO (voltage controlled oscillator) 57. The VCO 57 changes the frequency of its output clock signal in accordance with the input voltage. The clock signal outputted from the VCO 57 is supplied to the address control circuit 24. The clock signal thus supplied to the address control circuit 24 is used for generating a timing signal in the address control circuit 24.

The output of the VCO 57 is delivered also to a frequency divider 55. The frequency divider 55 divides the frequency of the input clock signal and then supplies the result as a PLL reference signal to the phase comparator 54. Thus, the above phase comparator 54, LPF 56, VCO 57 and frequency divider 55 constitute a phase comparison loop where the phase difference between the PLL reference signal and the PLL input signal obtained from the wobble signal is reduced to zero.

The wobble signal supplied from the optical head 22 to the wobble circuit 23 is obtained from the embossed pits in the ROM track as well as from the grooves in the recording track (FIG. 3). Therefore, even in case the address information composed of the embossed pits is read out merely partially due to the existence of some dust or the like deposited on the surface of the optical disk 11, it is still possible to execute the process in the synchronous circuits by using both the address information thus read out and the sync signal obtained from the wobble signal, hence specifying the desired position for recording or reproduction.

Consequently, a satisfactory result is achievable with a low error-rate address quality, and no problem is raised even in case the optical disk 11 has such a thickness that harmful influence is caused by some dust or the like on the disk surface, whereby the address format can be formed efficiently.

The wobble carrier frequency is rendered single, and both the frequency and the reference position information can be recorded on the optical disk 11. More specifically, the frequency represented by the frequency information is processed through a PLL to thereby realize acquisition of high-precision recording/reproducing clock information (angle information) based on the reference position information of the disk. And due to such clock information, it becomes possible to attain high-density recording and reproduction without redundancy.

The rotation of the disk can be controlled by first processing the wobble signal and the reference frequency through a PLL in a manner to achieve a desired disk rotation rate, and then controlling the spindle motor by the error signal obtained as a result.

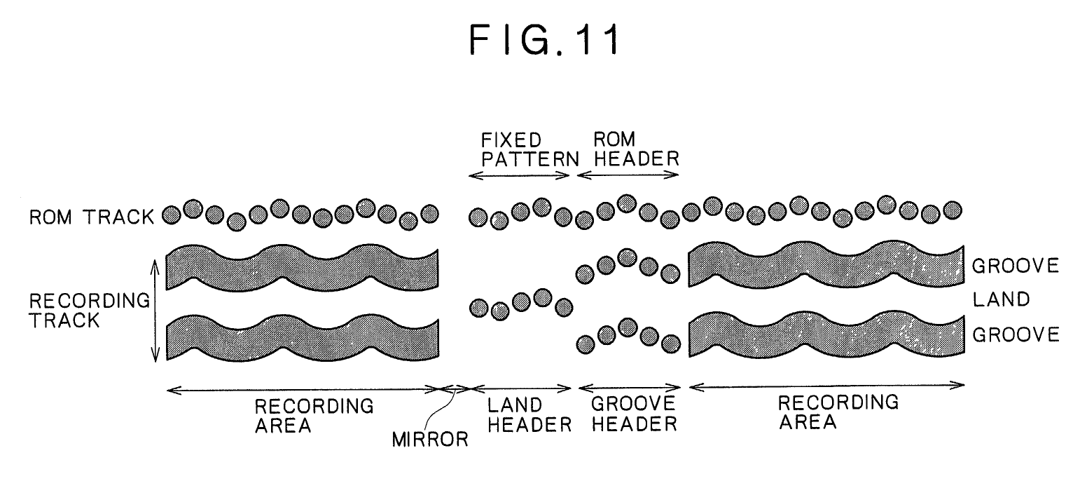

In the embodiment mentioned above, as shown in FIG. 3, the data composed of embossed pits in the recording area next to a fixed pattern and a ROM header in the ROM track are wobbled in the same wavelength as that of the grooves in the recording track. However, the embossed pits in the fixed pattern and the ROM header may be wobbled in the same wavelength as that of the grooves in the recording track, as shown in FIG. 11. Further, the embossed pits in the land header in the recording track and the embossed pits in the groove header may be wobbled in the same wavelength as that of the grooves.

The above processing routine may be executed by software as well as by hardware. When the processing routine is to be executed by software, it is installed from a recording medium into a computer where a program constituting the software is incorporated in exclusive hardware, or into a general-purpose personal computer or the like where various functions are executable by installing required programs.

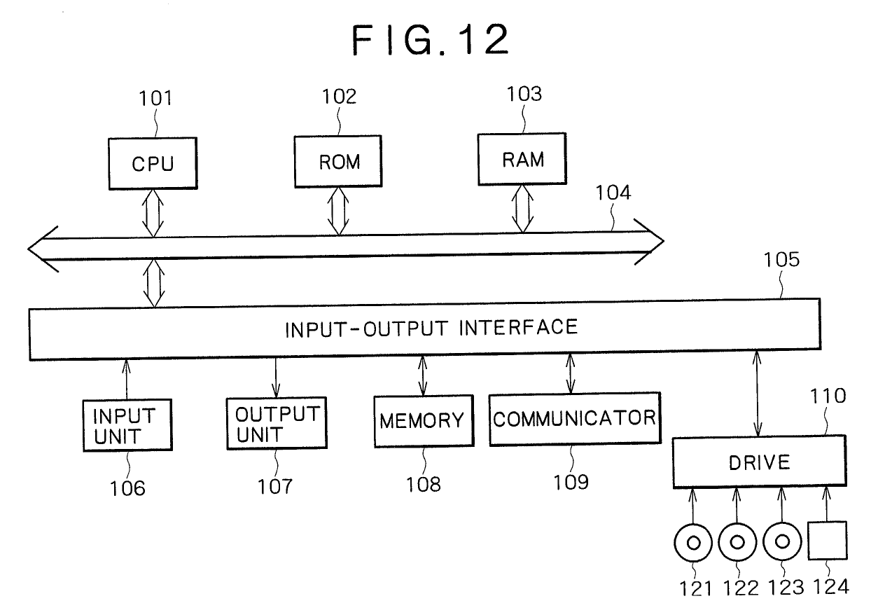

As shown in FIG. 12, the recording medium consists of a package where a programs is recorded to be provided for users separately from the computer, such as a magnetic disk 121 (including floppy disk), an optical disk 122 (including CD-ROM (compact disk-read only memory) and DVD (digital versatile disk)), a magneto-optical disk 123 (including MD (mini disk)), or a semiconductor memory 124. In addition, the recording medium further consists of a hard disk such as a ROM 102 or a memory 108 incorporated previously in the computer to store a program to be provided for users.

In this specification, the steps that describe the program provided by the medium are executed in time series in accordance with the mentioned sequence, or may be executed in parallel or individually without being restricted to the time series processing.

Also in this specification, a term “system” connotes the whole equipment comprising a plurality of apparatus and devices.

Thus, according to the recording apparatus, recording method and recording medium mentioned above, grooves and pits are formed while being wobbled on the basis of the generated frequency, so that the data can be reproduced on the reproducing side by using the sync signal obtained out of the wobble signal.

According to the aforementioned reproducing apparatus, reproducing method and recording medium, the data composed of pits are reproduced by using the sync signal obtained out of the wobble signal from the recording medium where the wobbled pits are recorded, so that exact reproduction of the data can be performed with certainty.

Further according to the aforementioned recording medium, grooves are formed with wobbles, and pits are recorded while being wobbled in the same period as that of the grooves, so that in reproduction of such recording medium, the data can be reproduced by using the sync signal obtained out of the wobble signal, hence ensuring exact reproduction of the data with certainty.

Although the present invention has been described hereinabove with reference to some preferred embodiments thereof, it is to be understood that the invention is not limited to such embodiments alone, and a variety of other changes and modifications will be apparent to those skilled in the art without departing from the spirit of the invention.

What is claimed is:

1. A recording apparatus comprising:
first forming means to form grooves;
second forming means to form pits; and
generating means to generate a predetermined frequency;
wherein said first forming means and said second forming means form the grooves and the pits, respectively, while wobbling the same in accordance with the frequency generated by said generating means.

2. A recording method comprising:
a first forming step to form grooves;
a second forming step to form pits; and
a generating step to generate a predetermined frequency;
wherein said first forming step and said second forming step are executed to form the grooves and the pits, respectively, while wobbling the same in accordance with the frequency generated at said generating step.

3. A recording medium where a program is recorded in a manner to be readable by a computer, said program comprising:
a first forming step to form grooves;
a second forming step to form pits; and
a generating step to generate a predetermined frequency;
wherein said first forming step and said second forming step are executed to form the grooves and the pits, respectively, while wobbling the same in accordance with the frequency generated at said generating step.

4. A reproducing apparatus for reproducing data composed of pits and recorded on a recording medium, wherein the pits are formed while being wobbled, and the data are reproduced by the use of a sync signal obtained from the wobbling.

5. A reproducing method for reproducing data composed of pits and recorded on a recording medium, wherein the pits are formed while being wobbled, said method reproducing the data by the use of a sync signal obtained from the wobbling.

6. A recording medium where a program is recorded in a manner to be readable by a computer, said program being executed to reproduce data which are composed of pits and are recorded on the recording medium, wherein the pits are formed while being wobbled, and the data are reproduced by the use of a sync signal obtained from the wobbling.

7. A recording medium containing recorded grooves and pits, wherein the grooves are formed while being wobbled, and the pits are also wobbled in the same period as that of the grooves.

8. The recording medium according to claim 7, wherein said pits include address information, and the address information is composed of at least one of PLL pull-in information, segment mark, address mark, address, and error detection code.

9. The recording medium according to claim 7, wherein the wobbling amplitude to the pits is more than twice the wobbling amplitude to the grooves.

10. The recording medium according to claim 7, wherein the pits are formed in CAV (constant angular velocity) zones.

11. The recording medium according to claim 7, wherein the grooves an d the land interposed between the grooves are formed in CAV zones respectively, and each of the grooves and the lands is composed of an address part and a data part, and the address parts of the grooves and the address parts of the adjacent lands are formed in zigzag.
